(19) United States
(12) Patent Application Publication
(10) Pub. No.: US 2023/0160398 A1
(43) Pub. Date: May 25, 2023

(54) COMPRESSION SYSTEM FOR A GAS TURBINE, HIGH-PRESSURE COMPRESSOR, COMPRESSION SYSTEM COMPRISING A HIGH-PRESSURE COMPRESSOR, LOW-PRESSURE COMPRESSOR, COMPRESSION SYSTEM COMPRISING A LOW-PRESSURE COMPRESSOR, AND GAS TURBINE

(71) Applicant: MTU Aero Engines AG, Munchen (DE)

(72) Inventor: Harsimar Sahota, Unterschleissheim (DE)

(73) Assignee: MTU Aero Engines AG, Munchen (DE)

(21) Appl. No.: 18/057,256

(22) Filed: Nov. 21, 2022

(30) Foreign Application Priority Data
Nov. 25, 2021 (DE) 10 2021 130 997.2

(51) Int. Cl. F04D 29/54; F04D 19/02

(52) U.S. Cl. CPC F04D 29/545; F04D 29/542; F04D 19/028

(57) ABSTRACT

The invention relates to a compression system for a gas turbine, in particular for an aircraft gas turbine, wherein the compression system comprises a flow duct. The flow duct includes cross-sectional areas that are aligned perpendicular to the axial direction along the flow duct length and have the respective predetermined sizes, where the inlet cross-sectional area has a size that is 15.3 to 16.1 times a size of the outlet cross-sectional area, and/or a cross-sectional area arranged at a distance of 40% of the flow duct length from the inlet cross-sectional area has a size that is 5.0 to 5.2 times the size of the outlet cross-sectional area.

The project that has led to this invention has received funding from the “Clean Sky 2” Joint Undertaking (CSJU) as part of the EU Horizon 2020 Research and Innovation program under grant agreement number 807085.

### BACKGROUND OF THE INVENTION

The invention relates to a compression system for a gas turbine, a high-pressure compressor for a compression system for a gas turbine, a compression system for a gas turbine, comprising a high-pressure compressor, a low-pressure compressor for a compression system for a gas turbine, and a compression system for a gas turbine, comprising a low-pressure compressor, as well as a gas turbine, comprising at least one compression system.

Gas turbines have at least one compression system, which is provided to compress air that is sucked in by the gas turbine before it is fed to the combustion chamber. For compression in aircraft turbines, the compression systems comprise axial compressors, which are set up to supply kinetic energy to the air by way of rotating blades, which rotate around a shaft of the compression system. In general, compression systems are multistage in construction, with various compressors of the compression system being arranged one behind the other in an axial direction. The compressors comprise a low-pressure compressor and a high-pressure compressor along an axially extending main flow path of the air. The low-pressure compressor, which is also referred to as a booster, serves the function of sucking in the air and pre-compressing the sucked-in air. The pre-compressed air is expelled at an outlet guide vane assembly of the low-pressure compressor and fed to the high-pressure compressor through a transition duct, which is arranged in the axial direction between the low-pressure compressor and the high-pressure compressor. The high-pressure compressor further compresses the air, so that it can be fed to the combustion chamber.

The air flows through the compression system along a flow duct, which is delimited by duct walls of the compression system in the radial direction with respect to the shaft of the compression system. For a high efficiency of the compression system, it is necessary to design the flow duct in terms of its geometry so as to achieve optimal control of a conducted flow of air.

Known from the prior art are solutions that make possible an optimization of a conducted flow.

Disclosed in DE 10 2016 115 868 A1 is a fluid working machine with a high utilization factor. The fluid working machine has a main flow path formed by a hub and a housing. Provided in the main flow path is at least one arrangement of rotating blades that supply energy to a fluid and form a rotor assembly. The fluid working machine comprises at least one arrangement of stationary blades that are arranged in the main flow path adjacent to the rotor and form a stator assembly, whereby, in each case, one rotor assembly and one stator assembly adjacent to it form one stage of the fluid working machine. It is provided that, in at least one stage, the averaged blade profile angles of the rotor assembly and the averaged blade profile angles of the stator assembly as well as the course of the cross-sectional areas of the main flow path in the downstream flow direction are chosen in such a way that they satisfy a certain relation.

EP 2 275 647 A2 discloses a fluid working machine with a blade row group. The fluid working machine comprises a main flow path formed by a rotating shaft and a housing, in which at least one arrangement of rotating blades that form a rotor and supply energy to the fluid is provided and in which, in the main flow direction adjacent to the rotor, an arrangement of stationary vanes that form a stator is provided. It is provided that, in at least one stage comprising a rotor arrangement and a stator arrangement, an area cross-section course of the main flow path leads to an elevated rotor-stator constriction ratio that satisfies a predetermined relation.

DE 10 2004 042 699 A1 discloses a flow structure for a gas turbine. The flow structure for the gas turbine, in particular for an aircraft engine, has support ribs that are positioned in the transition duct between two compressors or in a transition duct between two turbines or in a transition duct of a turbine outlet housing downstream of a low-pressure turbine and are spaced apart from one another in the peripheral direction of the transition duct. It is provided that a duct wall delimiting the transition duct radially inwardly and/or a duct wall delimiting the transition duct radially outwardly is retracted inward into the transition duct in the region of the flow outlet edges of the support ribs.

Disclosed in EP 2 159 398 B1 is a delamination-insensitive flow inlet duct for turbine midframes. It is provided that the arrangements comprise a duct that defines a general annular flow pathway. The duct comprises a front duct portion, which defines an increasing radius of the flow pathway in a downstream direction. It is provided that the duct comprises a downstream duct portion that is situated adjacent to and behind the front duct portion, with the downstream duct portion defining an arch that extends into the generally annular flow pathway The arrangement comprises a turbine midframe blade, which is positioned in the downstream duct portion, with a front edge of the turbine midframe blade being positioned in the arch in the downstream duct portion.

EP 2 660 424 B1 discloses a turbine connection duct of a gas turbine motor, wherein the turbine connection duct extends from a first outlet of a first turbine to a second inlet of a second turbine and is designed in such a way that it conducts a flow of air coming from the first turbine to the second turbine, wherein the turbine connection duct has a first station with a meridional surface area and a second station with a second meridional surface area and the first station is situated upstream of the second station. An axial position at which the ratio of the meridional area transitions from a convergent course to a divergent course amounts to between 15% and 80% of the axial length. The second meridional area is smaller than the first meridional area.

### SUMMARY OF THE INVENTION

An object of the invention is to optimize a course of a flow duct of a compression system.

The object is achieved in accordance with the invention by a compression system for a gas turbine, a high-pressure compressor for a compression system for a gas turbine, a compression system for a gas turbine, comprising a high-pressure compressor, a low-pressure compressor for a compression system for a gas turbine, and a compression system for a gas turbine, comprising a low-pressure compressor. as well as a gas turbine, comprising at least one compression system as described in detail hereinbelow.

Advantageous embodiments with expedient further developments of the invention are also described herein, whereby advantageous embodiments of each aspect of the invention are also to be regarded as advantageous embodiments of each of the other aspects of the invention.

A first aspect of the invention relates to a compression system for a gas turbine, in particular for an aircraft gas turbine. The compression system comprises a flow duct, which extends over a flow duct length from an inlet cross-sectional area of an inlet guide vane assembly of a low-pressure compressor in an axial direction of the compression system to an outlet cross-sectional area of an outlet guide vane assembly of a high-pressure compressor of the compression system. In other words, the compression system comprises the flow duct that extends through at least the low-pressure compressor of the compression system and at least the high-pressure compressor of the compression system. The flow duct is intended to provide a main flow path, which conducts sucked-in air for compression along the low-pressure compressor and the high-pressure compressor. The flow duct length describes an extension of the flow duct along the axial direction of the compression system. A beginning of the flow duct length is defined at the inlet cross-sectional area of the inlet assembly of the low-pressure compressor. An end of the flow duct length is predetermined at the outlet cross-sectional area of the outlet guide vane assembly of the high-pressure compressor.

The flow duct is delimited radially inwardly by a duct inner wall of the compression system and is delimited radially outwardly by a duct outer wall of the compression system. In other words, the compression system comprises the duct inner wall, which is a radially inwardly directed delimitation of the flow duct. The compression system comprises the duct outer wall, by means of which the flow duct is delimited outwardly. The duct inner wall and the duct outer wall can be aligned coaxially with respect to each other, with it being possible for the duct inner wall to have a smaller radius than the duct outer wall. It is provided that the flow duct comprises cross-sectional areas that are aligned perpendicular to the axial direction along the flow duct length and have the respective predetermined sizes. In other words, the cross-sectional areas aligned perpendicular to the axial direction of the compression system have the respective predetermined sizes.

It is hereby provided that the inlet cross-sectional area has a size that amounts to 15.3-16.1 times a size of the outlet cross-sectional area. In other words, the size of the inlet cross-sectional area is obtained by multiplying the outlet cross-sectional area by a value that is at least 15.3 and at most 16.1. Accordingly, the value can be, in particular, 15.3, 15.4, 15.5, 15.6, 15.7, 15.8, 15.9, 16.0, or 16.1.

Additionally or alternatively to this, it is provided that a cross-sectional area arranged at a distance of 40% of the flow duct length from the inlet cross-sectional area has a size that amounts to 5.0-5.2 times the size of the outlet cross-sectional area. In other words, it is provided that the cross-sectional area situated at a distance of 40% of the flow duct length from the inlet cross-sectional area has a size that is obtained by multiplying the size of the outlet cross-sectional area by a factor that is at least 5.0 and at most 5.2. Accordingly, the factor can be, in particular, 5.0, 5.1, or 5.2.

Additionally or alternatively to this, it is provided that a cross-sectional area arranged at a distance of 60% of the flow duct length from the inlet cross-sectional area has a size that amounts to 2.0-2.2 times the size of the outlet cross-sectional area. In other words, it is provided that the cross-sectional area situated at a distance of 60% of the flow duct length from the inlet cross-sectional area has a size that is obtained by multiplying the size of the outlet cross-sectional area by a factor that is at least 2.0 and at most 2.2. The factor can be, in particular, 2.0, 2.1, or 2.2. The invention affords the advantage that a course of the cross-sectional area of the flow duct that has an especially small flow resistance is provided. Through an optimization of the entire system, it is possible to alter the area course or curve in such a way that lower Mach numbers and, in consequence thereof, a marked advantage in terms of the degree of efficiency can be achieved not only for the entire compression system, but also for the flow duct of the high-pressure compressor alone.

The invention also comprises further developments, which afford additional advantages.

A further development of the invention provides that a cross-sectional area arranged at a distance of 10% of the flow duct length from the inlet cross-sectional area has a size that amounts to 10.9-11.5 times the size of the outlet cross-sectional area. In other words, it is provided that the cross-sectional area situated at a distance of 10% of the flow duct length from the inlet cross-sectional area has a size that is obtained by multiplying the size of the outlet cross-sectional area by a factor that is least 10.9 and at most 11.5. The factor can be, in particular, 10.9, 11.0, 11.1, 11.2, 11.3, 11.4, or 11.5.

Additionally or alternatively to this, it is provided that a cross-sectional area arranged at a distance of 30% of the flow duct length from the inlet cross-sectional area has a size that amounts to 5.2-5.5 times the size of the outlet cross-sectional area. In other words, it is provided that the cross-sectional area situated at a distance of 30% of the flow duct length from the inlet cross-sectional area has a size that is obtained by multiplying the size of the outlet cross-sectional area by a factor that is at least 5.2 and at most 5.5. The factor can be, in particular, 5.2, 5.3, 5.4, or 5.5.

Additionally or alternatively to this, it is provided that a cross-sectional area arranged at a distance of 50% of the flow duct length from the inlet cross-sectional area has a size that amounts to 3.0-3.4 times the size of the outlet cross-sectional area. In other words, it is provided that the cross-sectional area situated at a distance of 50% of the flow duct length from the inlet cross-sectional area has a size that is obtained by multiplying the size of the outlet cross-sectional area by a factor that is at least 3.0 and at most 3.4. The factor can be, in particular, 3.0, 3.1, 3.2, 3.3, or 3.4.

Additionally or alternatively to this, it is provided that a cross-sectional area arranged at a distance of 70% of the flow duct length from the inlet cross-sectional area has a size that amounts to 1.5 to 1.6 times the size of the outlet cross-sectional area. In other words, it is provided that the cross-sectional area situated at a distance of 70% of the flow duct length from the inlet cross-sectional area has a size that is obtained by multiplying the size of the outlet cross-sectional area by a factor that is at least 1.5 and at most 1.6. The factor can be, in particular, 1.5 or 1.6.

A further development of the invention provides that a cross-sectional area arranged at a distance of 35% of the flow duct length from the inlet cross-sectional area has a size that amounts to 4.6 to 4.8 times the size of the outlet cross-sectional area. In other words, it is provided that the cross-sectional area situated at a distance of 35% of the flow duct length from the inlet cross-sectional area has a size that is obtained by multiplying the size of the outlet cross-sectional area by a factor that is at least 1.5 and at most 1.6. The factor can be, in particular, 1.5 or 1.6.

Additionally or alternatively to this, it is provided that a cross-sectional area arranged at a distance of 37.5% of the flow duct length from the inlet cross-sectional area has a size that amounts to 4.8-5.2 times the size of the outlet cross-sectional area. In other words, it is provided that the cross-sectional area situated at a distance of 37.5% of the flow duct length from the inlet cross-sectional area has a size that is obtained by multiplying the size of the outlet cross-sectional area by a factor that is at least 4.8 and at most 5.2. The factor can be, in particular, 4.8, 4.9, 5.0, 5.1, or 5.2.

Additionally or alternatively to this, it is provided that a cross-sectional area arranged at a distance of 42.5% of the flow duct length from the inlet cross-sectional area has a size that amounts to 4.6-4.8 times the size of the outlet cross-sectional area. In other words, it is provided that the cross-sectional area situated at a distance of 42.5% of the flow duct length from the inlet cross-sectional area has a size that is obtained by multiplying the size of the outlet cross-sectional area by a factor that is at least 4.6 and at most 4.8. The factor can be, in particular, 4.6, 4.7, or 4.8.

Additionally or alternatively to this, it is provided that a cross-sectional area arranged at a distance of 45% of the flow duct length from the inlet cross-sectional area has a size that amounts to 4.0-4.2 times the size of the outlet cross-sectional area. In other words, it is provided that the cross-sectional area situated at a distance of 45% of the flow duct length from the inlet cross-sectional area has a size that is obtained by multiplying the size of the outlet cross-sectional area by a factor that is at least 4.0 and at most 4.2. The factor can be, in particular, 4.0, 4.1, or 4.2.

A further development of the invention provides that a cross-sectional area arranged at a distance of 80% of the flow duct length from the inlet cross-sectional area has a size that amounts to 1.2-1.3 times the size of the outlet cross-sectional area. In other words, it is provided that the cross-sectional area situated at a distance of 80% of the flow duct length from the inlet cross-sectional area has a size that is obtained by multiplying the size of the outlet cross-sectional area by a factor that is at least 1.2 and at most 1.3. The factor can be, in particular, 1.2 or 1.3.

A second aspect of the invention relates to a high-pressure compressor for a compression system of a gas turbine, in particular for an aircraft gas turbine. It is provided that the high-pressure compressor comprises a flow duct of the high-pressure compressor that extends from an inlet cross-sectional area of an inlet guide vane assembly of the high-pressure compressor over a flow duct length of the high-pressure compressor, which extends in an axial direction of the high-pressure compressor to an outlet cross-sectional area of an outlet guide vane assembly of the high-pressure compressor, with the flow duct of the high-pressure compressor being delimited radially inwardly by a duct inner wall the high-pressure compressor and radially outwardly by a duct outer wall of the high-pressure compressor. In other words, the high-pressure compressor comprises the flow duct of the high-pressure compressor that extends from the inlet cross-sectional area of the inlet guide vane assembly of the high-pressure compressor to the outlet cross-sectional area of the outlet guide vane assembly of the high-pressure compressor. Along the axial direction of the high-pressure compressor, the flow duct of the high-pressure compressor has the flow duct length of the high-pressure compressor. The high-pressure compressor has a duct inner wall that delimits the flow duct of the high-pressure compressor radially inward. The high-pressure compressor has a duct outer wall that delimits the flow duct of the high-pressure compressor radially outward. In other words, the flow duct of the high-pressure compressor is delimited radially by the duct walls. The duct inner wall and the duct outer wall can be aligned, for example, coaxially with respect to each other, with it being possible for the duct inner wall to have a smaller radius than the duct outer wall.

It is provided that, along the flow duct length of the high-pressure compressor, the flow duct of the high-pressure compressor comprises cross-sectional areas that are aligned perpendicular to the axial direction and have the respective predetermined sizes. In other words, the flow duct of the high-pressure compressor has cross-sectional areas that are aligned perpendicular to the axial direction and have the respectively predetermined sizes. It is hereby provided that the inlet cross-sectional area of the high-pressure compressor has a size that amounts to 4.8-5.6 times a size of the outlet cross-sectional area of the high-pressure compressor. The factor can be, in particular, 4.8, 4.9, 5.0, 5.1, 5.2, 5.3, 5.4, 5.5, or 5.6.

Additionally or alternatively to this, it is provided that a cross-sectional area arranged at a distance of 22% of the flow duct length of the high-pressure compressor from the inlet cross-sectional area has a size that amounts to 2.8-3.3 times the size of the outlet cross-sectional area. In other words, it is provided that the cross-sectional area situated at a distance of 22% of the flow duct length of the high-pressure compressor from the inlet cross-sectional area of the high-pressure compressor has a size that is obtained by multiplying the size of the outlet cross-sectional area of the high-pressure compressor by a factor that is at least 2.8 and at most 3.3. The factor can be, in particular, 2.8, 2.9, 3.0, 3.1, 3.2, or 3.3.

Additionally or alternatively to this, it is provided that a cross-sectional area arranged at a distance of 39% of the flow duct length of the high-pressure compressor from the inlet cross-sectional area of the high-pressure compressor has a size that amounts to 1.9-2.1 times the size of the outlet cross-sectional area of the high-pressure compressor. In other words, it is provided that the cross-sectional area situated at a distance of 39% of the flow duct length of the high-pressure compressor from the inlet cross-sectional area of the high-pressure compressor has a size that is obtained by multiplying the size of the outlet cross-sectional area by a factor that is at least 1.9 and at most 2.1. The factor can be, in particular, 1.9, 2.0, or 2.1.

Additionally or alternatively to this, it is provided that a cross-sectional area arranged at a distance of 61% of the flow duct length of the high-pressure compressor from the inlet cross-sectional area of the high-pressure compressor has a size that amounts to 1.4-1.5 times the size of the outlet cross-sectional area. In other words, it is provided that the cross-sectional area situated at a distance of 61% of the flow duct length of the high-pressure compressor from the inlet cross-sectional area of the high-pressure compressor has a size that is obtained by multiplying the size of the outlet cross-sectional area by a factor that is at least 1.4 and at most 1.5. The factor can be, in particular, 1.4 or 1.5.

Additionally or alternatively to this, it is provided that a cross-sectional area arranged at a distance of 83% of the flow duct length of the high-pressure compressor from the inlet cross-sectional area of the high-pressure compressor has a size that amounts to 1.1 times the size of the outlet cross-sectional area. In other words, it is provided that the cross-sectional area situated at a distance of 83% of the flow duct length of the high-pressure compressor from the inlet cross-sectional area of the high-pressure compressor has a size that is obtained by multiplying the size of the outlet cross-sectional area by a factor that is 1.1.

A further development of the invention provides that the high-pressure compressor flow duct has a cross-sectional area arranged at a distance of 11% of the flow duct length of the high-pressure compressor from the inlet cross-sectional area of the high-pressure compressor, having a size that amounts to 3.8-4.4 times the size of the outlet cross-sectional area. In other words, it is provided that the cross-sectional area situated at a distance of 11% of the flow duct length of the high-pressure compressor from the inlet cross-sectional area has a size that is obtained by multiplying the size of the outlet cross-sectional area by a factor that is at least 3.8 and at most 4.4. The factor can be, in particular, 3.8, 3.9, 4.0, 4.1, 4.2, 4.3, or 4.4.

Additionally or alternatively to this, it is provided that a cross-sectional area arranged at a distance of 33% of the flow duct length of the high-pressure compressor from the inlet cross-sectional area of the high-pressure compressor has a size that amounts to 2.1-2.8 times the size of the outlet cross-sectional area. In other words, it is provided that the cross-sectional area situated at a distance of 33% of the flow duct length of the high-pressure compressor from the inlet cross-sectional area has a size that is obtained by multiplying the size of the outlet cross-sectional area by a factor that is at least 2.1 and at most 2.4. The factor can be, in particular, 2.1, 2.2, 2.3, or 2.4.

Additionally or alternatively to this, it is provided that a cross-sectional area arranged at a distance of 50% of the flow duct length of the high-pressure compressor from the inlet cross-sectional area of the high-pressure compressor has a size that amounts to 1.6-1.7 times the size of the outlet cross-sectional area. In other words, it is provided that the cross-sectional area situated at a distance of 50% of the flow duct length of the high-pressure compressor from the inlet cross-sectional area has a size that is obtained by multiplying the size of the outlet cross-sectional area by a factor that is at least 1.6 and at most 1.7. The factor can be, in particular, 1.6 or 1.7.

Additionally or alternatively to this, it is provided that a cross-sectional area arranged at a distance of 72% of the flow duct length of the high-pressure compressor from the inlet cross-sectional area of the high-pressure compressor has a size that amounts to 1.2-1.3 times the size of the outlet cross-sectional area. In other words, it is provided that the cross-sectional area situated at a distance of 72% of the flow duct length of the high-pressure compressor from the inlet cross-sectional area has a size that is obtained by multiplying the size of the outlet cross-sectional area by a factor that is at least 1.2 and at most 1.3. The factor can be, in particular, 1.2 or 1.3.

Additionally or alternatively to this, it is provided that a cross-sectional area arranged at a distance of 89% of the flow duct length of the high-pressure compressor from the inlet cross-sectional area of the high-pressure compressor has a size that amounts to 1.1 times the size of the outlet cross-sectional area. In other words, it is provided that the cross-sectional area situated at a distance of 89% of the flow duct length of the high-pressure compressor from the inlet cross-sectional area of the high-pressure compressor has a size that is obtained by multiplying the size of the outlet cross-sectional area by a factor that is 1.1.

A third aspect of the invention relates to a compression system for a gas turbine, in particular for an aircraft gas turbine, that comprises at least one high-pressure compressor.

A fourth aspect of the invention relates to a low-pressure compressor of a compression system of a gas turbine, in particular for an aircraft gas turbine. It is provided that the low-pressure compressor comprises a low-pressure compressor flow duct that extends from an inlet cross-sectional area of an inlet guide vane assembly of the low-pressure compressor over a low-pressure compressor duct flow length that extends in an axial direction of the low-pressure compressor to an outlet cross-sectional area of an outlet guide vane assembly of the low-pressure compressor, with the flow duct of the low-pressure compressor being delimited radially inwardly by a duct inner wall of the low-pressure compressor and radially outwardly by a duct outer wall of the low-pressure compressor. In other words, the low-pressure compressor comprises the low-pressure compressor flow duct, which extends from the inlet cross-sectional area of the inlet guide vane assembly of the low-pressure compressor to the outlet cross-sectional area of the outlet guide vane assembly of the low-pressure compressor. Along the axial direction of the low-pressure compressor, the flow duct of the low-pressure compressor has the flow duct length of the low-pressure compressor.

The compression system comprises a flow duct, which extends from the inlet cross-sectional area of an inlet guide vane assembly of a low-pressure compressor over a flow duct length in an axial direction of the compression system to an outlet cross-sectional area of an outlet guide vane assembly of a high-pressure compressor of the compression system. In other words, the compression system comprises the flow duct that extends through the low-pressure compressor of the compression system and at least the high-pressure compressor of the compression system. The flow duct is intended for providing a main flow path, which conducts sucked-in air for compression along the low-pressure compressor and the high-pressure compressor.

The low-pressure compressor has a duct inner wall that delimits the flow duct of the low-pressure compressor radially inward. The low-pressure compressor has a duct outer wall that delimits the flow duct of the low-pressure compressor outward. In other words, flow duct of the low-pressure compressor is delimited radially by the duct walls. The duct inner wall and the duct outer wall can be aligned, for example, coaxially with respect to each other, with it being possible for the duct inner wall to have a smaller radius than the duct outer wall.

It is provided that the flow duct of the low-pressure compressor comprises cross-sectional areas that are aligned perpendicular to the axial direction along the flow duct length of the low-pressure compressor and have the respective predetermined sizes. In other words, the flow duct of the low-pressure compressor has cross-sectional areas that are aligned perpendicular to the axial direction and have the respectively predetermined sizes. It is hereby provided that the inlet cross-sectional area of the low-pressure compressor has a size that amounts to 15.4-16.1 times a size of the outlet cross-sectional area of the high-pressure compressor. The factor can be, in particular, 15.4, 15.5, 15.6, 15.7, 15.8, 15.9, 16.0, or 16.1.

Additionally or alternatively to this, it is provided that a cross-sectional area arranged at a distance of 20% of the flow duct length of the low-pressure compressor from the inlet cross-sectional area has a size that amounts to 13.3-13.8 times the size of the outlet cross-sectional area of the high-pressure compressor. In other words, it is provided that the cross-sectional area situated at a distance of 20% of the flow duct length of the low-pressure compressor from the inlet cross-sectional area of the low-pressure compressor has a size that is obtained by multiplying the size of the outlet cross-sectional area of the high-pressure compressor by a factor that is at least 13.3 and at most 13.8. The factor can be, in particular, 13.3, 13.4, 13.5, 13.6, 13.7, or 13.8.

Additionally or alternatively to this, it is provided that a cross-sectional area arranged at a distance of 40% of the flow duct length of the low-pressure compressor from the inlet cross-sectional area of the low-pressure compressor has a size that amounts to 9.4-9.7 times the size of the outlet cross-sectional area of the high-pressure compressor. In other words, it is provided that the cross-sectional area situated at a distance of 40% of the flow duct length of the low-pressure compressor from the inlet cross-sectional area of the low-pressure compressor has a size that is obtained by multiplying the size of the outlet cross-sectional area of the high-pressure compressor by a factor that is at least 9.4 and at most 9.7. The factor can be, in particular, 9.4, 9.5, 9.6, or 9.7.

Additionally or alternatively to this, it is provided that a cross-sectional area arranged at a distance of 60% of the flow duct length of the low-pressure compressor from the inlet cross-sectional area of the low-pressure compressor has a size that amounts to 7.2-7.4 times the size of the outlet cross-sectional area of the high-pressure compressor. In other words, it is provided that the cross-sectional area situated at a distance of 60% of the flow duct length of the low-pressure compressor from the inlet cross-sectional area of the low-pressure compressor has a size that is obtained by multiplying the size of the outlet cross-sectional area of the high-pressure compressor by a factor that is at least 7.2 and at most 7.4. The factor can be, in particular, 7.2, 7.3, or 7.4.

Additionally or alternatively to this, it is provided that a cross-sectional area arranged at a distance of 80% of the flow duct length of the low-pressure compressor from the inlet cross-sectional area of the low-pressure compressor has a size that amounts to 5.9 times the size of the outlet cross-sectional area of the high-pressure compressor. In other words, it is provided that the cross-sectional area situated at a distance of 80% of the flow duct length of the low-pressure compressor from the inlet cross-sectional area of the low-pressure compressor has a size that is obtained by multiplying the size of the outlet cross-sectional area of the high-pressure compressor by a factor that is 5.9.

Additionally or alternatively to this, it is provided that the outlet cross-sectional area of the low-pressure compressor has a size that amounts to 5.1 times a size of the outlet cross-sectional area of the high-pressure compressor.

A further development of the invention provides that a cross-sectional area arranged at a distance of 10% of the flow duct length of the low-pressure compressor from the inlet cross-sectional area of the low pressure compressor has a size that amounts to 15.3-15.9 times the size of the outlet cross-sectional area of the high-pressure compressor. In other words, it is provided that the cross-sectional area situated at a distance of 10% of the flow duct length of the low-pressure compressor from the inlet cross-sectional area of the low-pressure compressor has a size that is obtained by multiplying the size of the outlet cross-sectional area of the high-pressure compressor by a factor that is at least 15.3 and at most 15.9. The factor can be, in particular, 15.3, 15.4, 15.5, 15.6, 15.7, 15.8, or 15.9.

Additionally or alternatively to this, it is provided that a cross-sectional area arranged at a distance of 30% of the flow duct length of the low-pressure compressor from the inlet cross-sectional area of the low-pressure compressor has a size that amounts to 11.2-11.5 times the size of the outlet cross-sectional area of the high-pressure compressor. In other words, it is provided that the cross-sectional area situated at a distance of 30% of the flow duct length of the low-pressure compressor from the inlet cross-sectional area of the low-pressure compressor has a size that is obtained by multiplying the size of the outlet cross-sectional area of the high-pressure compressor by a factor that is at least 11.2 and at most 11.5. The factor can be, in particular, 11.2, 11.3, 11.4, or 11.5.

Additionally or alternatively to this, it is provided that a cross-sectional area arranged at a distance of 50% of the flow duct length of the low-pressure compressor from the inlet cross-sectional area of the low-pressure compressor has a size that amounts to 8.2-8.4 times the size of the outlet cross-sectional area of the high-pressure compressor. In other words, it is provided that the cross-sectional area situated at a distance of 50% of the flow duct length of the low-pressure compressor from the inlet cross-sectional area of the low-pressure compressor has a size that is obtained by multiplying the size of the outlet cross-sectional area of the high-pressure compressor by a factor that is at least 8.2 and at most 8.4. The factor can be, in particular, 8.2, 8.3, or 8.4.

Additionally or alternatively to this, it is provided that a cross-sectional area arranged at a distance of 70% of the flow duct length of the low-pressure compressor from the inlet cross-sectional area of the low-pressure compressor has a size that amounts to 6.5-6.6 times the size of the outlet cross-sectional area of the high-pressure compressor. In other words, it is provided that the cross-sectional area situated at a distance of 70% of the flow duct length of the low-pressure compressor from the inlet cross-sectional area of the low-pressure compressor has a size that is obtained by multiplying the size of the outlet cross-sectional area of the high-pressure compressor by a factor that is at least 6.5 and at most 6.6. The factor can be, in particular, 6.5 or 6.6.

Additionally or alternatively to this, it is provided that a cross-sectional area arranged at a distance of 90% of the flow duct length of the low-pressure compressor from the inlet cross-sectional area of the low-pressure compressor has a size that amounts to 5.4 times the size of the outlet cross-sectional area of the high-pressure compressor. In other words, it is provided that the cross-sectional area situated at a distance of 90% of the flow duct length of the low-pressure compressor from the inlet cross-sectional area of the low-pressure compressor has a size that is obtained by multiplying the size of the outlet cross-sectional area of the high-pressure compressor by a factor that is 5.4.

Further features and the advantages thereof can be taken from the descriptions of the first aspect of the invention and the second aspect of the invention.

A fifth aspect of the invention relates to a compression system for a gas turbine, in particular for an aircraft gas turbine, that comprises at least one low-pressure compressor.

Further features and the advantages thereof can be taken from the descriptions of the first aspect of the invention, of the second aspect of the invention, and the third aspect of the invention.

A sixth aspect of the invention relates to a gas turbine that comprises at least one compression system.

Further features and the advantages thereof can be taken from the descriptions of the first aspect of the invention, the second aspect of the invention, the third aspect of the invention, and the fourth aspect of the invention.

### BRIEF DESCRIPTION OF THE DRAWING FIGURES

Further features of the invention ensue from the claims, the figures, and the descriptions of the figures. The features and combinations of features mentioned above in the description as well as the features and combinations of features mentioned below in the descriptions of the figures and/or shown solely in the figures can be used not only in the respectively presented combination, but also in other combinations, without leaving the scope of the invention. Accordingly, embodiments of the invention that are not explicitly shown and explained in the figures, but which are derived from and can be produced by combinations of features from the explained embodiments, are also to be regard as comprised and disclosed. Accordingly, embodiments and combinations of features that do not have all features of an independent claim as originally formulated are also to be regard as being disclosed. Beyond this, embodiments and combinations of features, in particular through the presented embodiments, that go beyond the combinations of features presented in back reference to the claims or deviate from them are to be regard as being disclosed. Herein:

FIG. 1 shows a schematic illustration of a compression system for a gas turbine;

FIG. 2 shows a schematic illustration of a compression system for a gas turbine with corresponding size curves shown therebelow;

FIG. 3A shows a further schematic illustration of the compression system for a gas turbine and FIGS. 3B and 3C, respectively, show the corresponding curves for the sizes 18 of the cross-sectional areas 17 in the respective compressors 7, 10;

FIG. 4 shows a schematic illustration of a flow duct of the high-pressure compressor of a high-pressure compressor of a compression system for a gas turbine; and

FIG. 5 shows a schematic illustration of a low-pressure compressor flow duct of a low-pressure compressor of a compression system for a gas turbine.

### DESCRIPTION OF THE INVENTION

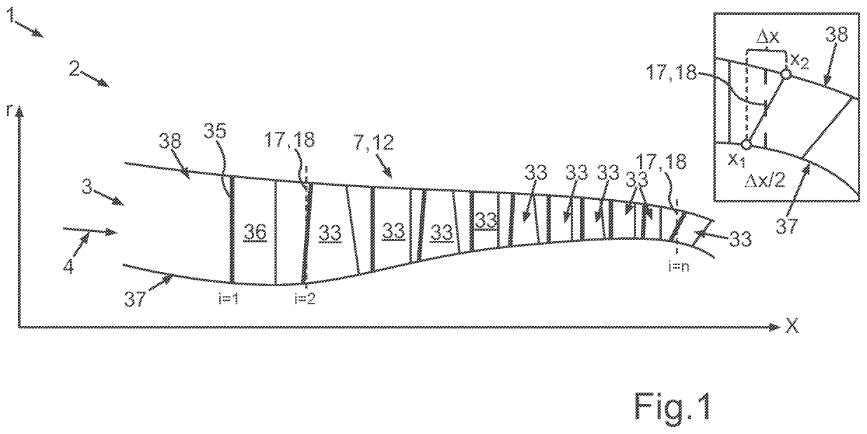

FIG. 1 shows a schematic illustration for explanation of the cross-sectional area. The relative vane assembly inlet position x is defined in relation to an index of the vane assembly inlet. The vane assembly inlet position x is defined by x=(i−1)/(n−1). The value n can be the index of the last vane assembly of the respective compressor. The value n can be 11 in the low-pressure compressor and 19 in the high-pressure compressor. The cross-sectional area can describe an area that is arranged perpendicular to the x axis at a middle axial vane assembly inlet-plane position Δx/2. It is situated at the arithmetic mean in a region Δx between a front vane assembly inlet-plane position x1 and a rear vane assembly inlet-plane position x2.

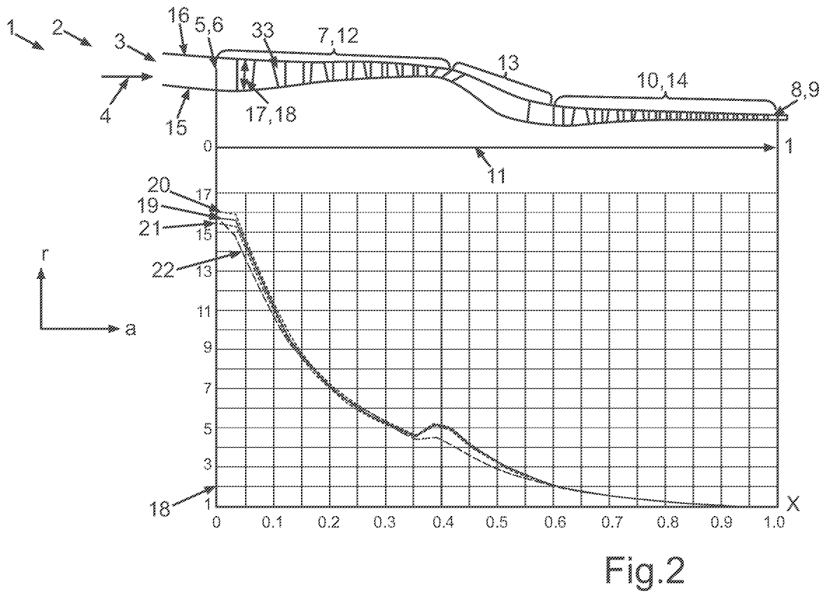

FIG. 2 shows a schematic illustration of a compression system for a gas turbine. The gas turbine 1 for which it is possible to provide the compression system 2 can be, in particular, an aircraft gas turbine for an airplane. The compression system 2 can comprise a flow duct 3. The flow duct 3 can be provided for conducting air along a flow path 4, which is predetermined by the flow duct 3, through the compression system 2. The flow duct 3 can extend from an inlet cross-sectional area 5 of an inlet guide vane assembly 6 of a low-pressure compressor 7 of the compression system 2 to an outlet cross-sectional area 8 of an outlet guide vane assembly 9 of a high-pressure compressor 10 of the compression system 2. The flow duct 3 can have a flow duct length 11. The flow duct length 11 can describe a length of the flow duct 3 along an axial direction a of the compression system 2. The axial direction a can be aligned parallel to a longitudinal direction of a shaft, which is not shown, or of a shaft arrangement of the compression system 2.

A beginning of the flow duct 3 can be the inlet cross-sectional area 5 of the inlet guide vane assembly 6 of the low-pressure compressor 7. An end can be the outlet cross-sectional area 8 of the outlet guide vane assembly 9 of the high-pressure compressor 10. The flow duct 3 can comprise three sections, whereby a first section of the flow duct 3 can be a low-pressure compressor flow duct 12 of the low-pressure compressor 7, to which an intermediate duct 13 and a high-pressure compressor flow duct 14 of a high-pressure compressor 10 can adjoin. The flow duct 3 can be delimited radially inwardly by a duct inner wall 15 of the compression system 2 and radially outwardly by a duct outer wall 16 of the compression system 2. A radial direction r can thereby be specified likewise in relation to a shaft or a shaft arrangement, whereby the radially inner delimitation can describe a delimitation of the flow duct 3 in a direction that can be aligned facing the shaft or the shaft arrangement of the compression system 2. The radially outer delimitation can describe a delimitation of the flow duct 3 in a direction that can be aligned facing away from the shaft or the shaft arrangement of the compression system 2.

Through the flow duct 3, the air sucked in by the low-pressure compressor 7 can be conducted along the flow path 4 through the low-pressure compressor 7, whereby kinetic energy can be applied to the air by the rotating wheels of the low-pressure compressor 7 in order to increase the density of the air. Accordingly, the air can have a higher density when it exits the low-pressure compressor 7 than it had prior to being sucked in by the low-pressure compressor 7.

The air can be fed through the intermediate duct 13 to the high-pressure compressor 10. Kinetic energy can likewise be applied to the air in the high-pressure compressor flow duct 14 of the high-pressure compressor 10 by rotating blades of the high-pressure compressor 10 in order to increase further the density of the air. The air can be expelled at the outlet guide vane assembly 9 of the high-pressure compressor 10 of the compression system 2 and, for example, be fed to a combustion chamber of the gas turbine 1.

In order to minimize any air resistance when air is conducted through the flow duct 3, it may be necessary to design cross-sectional areas 17 that can be arranged at respective positions along the flow duct 3 of the flow duct length 11 in such a way that a minimal air resistance acts by using a size curve 19 of the cross-sectional areas 17. Sizes 18 of the respective cross-sectional areas 17 can be defined in relation to a size of the outlet cross-sectional area 8 of the outlet guide vane assembly 9 of the high-pressure compressor 10. In other words, the sizes 18 of the respective cross-sectional areas 17 are relatively defined, with it being possible to set the sizes 18 of the respective cross-sectional areas 17 in relation to the size of the outlet cross-sectional area 8. It is possible to define at least some of the sizes 18 of the respective cross-sectional areas 17 at predetermined positions along the flow duct length 11. The positions of the respective cross-sectional areas 17 can likewise be relatively defined and can be set in relation to the flow duct length 11. The respective positions can be defined by distances of the respective cross-sectional areas 17 from the inlet cross-sectional area 5 of the inlet guide vane assembly 6 of the low-pressure compressor 7, with it being possible to predetermine the distance in relation to the flow duct length 11. In particular, a distance of a length of 0% of the flow duct length 11 can describe the position of the inlet cross-sectional area 5 of the inlet guide vane assembly 6 of the low-pressure compressor 7, a distance of a length of 50% of the flow duct length 11 can describe a position in the middle of the flow duct 3, and a distance of a length of 100% of the flow duct length 11 can describe a position of the outlet cross-sectional area 8 of the outlet guide vane assembly 9 of the high-pressure compressor 10.

The respective sizes 18 can lie in a predetermined range of values, so that the size curve 19 over the flow duct length 11 can have an upper limit 20 and a lower limit 21. Additionally shown is a size curve 22 in accordance with the prior art. In comparison to the size curve 22 in accordance with the prior art, in a region that can be situated at a distance of approximately 0.35-0.5 of the flow duct length 11 from the inlet cross-sectional area 5, a local increase in the sizes 18 can be seen. It has been found that, in particular, this increase has advantageous effects on the air resistance. Further guide vane assemblies 33 can be arranged in the flow duct 3. The sizes 18 of the cross-sectional areas 17 are given here in relation to the flow duct 3 itself and thus do not take into account reductions in the sizes 18 of the cross-sectional areas 17 due to areas of the vanes of the guide vane assembly 33. The size curve 22 in accordance with the prior art has a flatter area course, which leads to higher Mach numbers and thus to a lower degree of efficiency.

It can be provided, for example, that the inlet cross-sectional area 5 has a size 18, which is 15.4 to 16.1 times the size 18 of the outlet cross-sectional area 8, and/or
a cross-sectional area 17 arranged at a distance of 10% of the flow duct length 11 from the inlet cross-sectional area 5 has a size 18, which amounts to 10.9 to 11.5 times the size 18 of the outlet cross-sectional area 8, and/or
a cross-sectional area 17 arranged at a distance of 30% of the flow duct length 11 from the inlet cross-sectional area 5 has a size 18, which amounts to 5.2 to 5.5 times the size 18 of the outlet cross-sectional area 8, and/or
a cross-sectional area 17 arranged at a distance of 35% of the flow duct length 11 from the inlet cross-sectional area 5 has a size 18, which amounts to 4.6 to 4.8 times the size 18 of the outlet cross-sectional area 8, and/or
a cross-sectional area 17 arranged at a distance of 37.5% of the flow duct length 11 from the inlet cross-sectional area 5 has a size 18, which amounts to 4.8 to 5.2 times the size 18 of the outlet cross-sectional area 8, and/or
a cross-sectional area 17 arranged at a distance of 40% of the flow duct length 11 from the inlet cross-sectional area 5 has a size 18, which amounts to 5.0 to 5.2 times the size 18 of the outlet cross-sectional area 8, and/or
a cross-sectional area 17 arranged at a distance of 42.5% of the flow duct length 11 from the inlet cross-sectional area 5 has a size 18, which amounts to 4.6 to 4.8 times the size 18 of the outlet cross-sectional area 8, and/or
a cross-sectional area 17 arranged at a distance of 45% of the flow duct length 11 from the inlet cross-sectional area 5 has a size 18, which amounts to 4.0 to 4.2 times the size 18 of the outlet cross-sectional area 8, and/or
a cross-sectional area 17 arranged at a distance of 50% of the flow duct length 11 from the inlet cross-sectional area 5 has a size 18, which amounts to 3.0 to 3.4 times the size 18 of the outlet cross-sectional area 8, and/or
a cross-sectional area 17 arranged at a distance of 60% of the flow duct length 11 from the inlet cross-sectional area 5 has a size 18, which amounts to 2.0 to 2.2 times the size 18 of the outlet cross-sectional area 8, and/or
a cross-sectional area 17 arranged at a distance of 70% of the flow duct length 11 from the inlet cross-sectional area 5 has a size 18, which amounts to 1.5 to 1.6 times the size 18 of the outlet cross-sectional area 8, and/or
a cross-sectional area 17 arranged at a distance of 80% of the flow duct length 11 from the inlet cross-sectional area 5 has a size 18, which amounts to 1.2 to 1.3 times the size 18 of the outlet cross-sectional area 8.

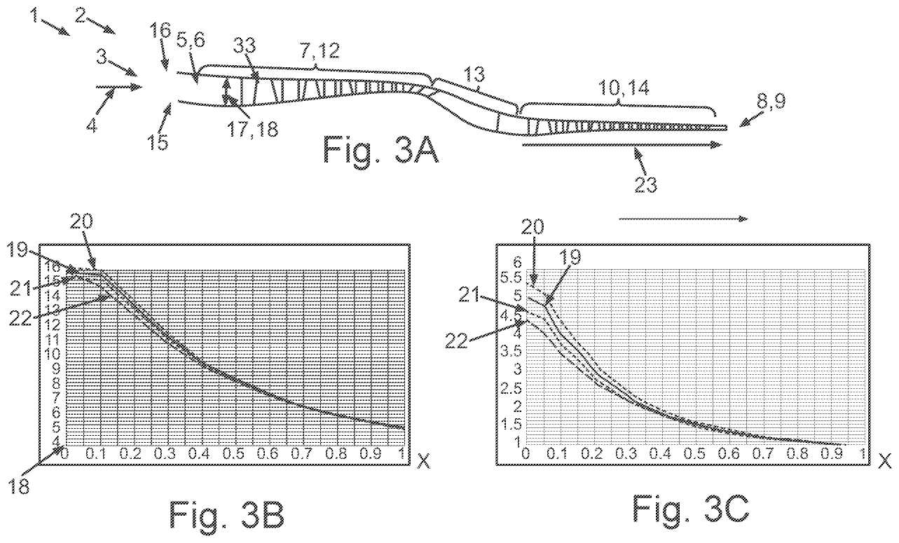

FIG. 3A shows a further schematic illustration of the compression system for a gas turbine and FIGS. 3B and 3C, respectively, show the corresponding curves for the sizes 18 of the cross-sectional areas 17 in the respective compressors 7, 10.

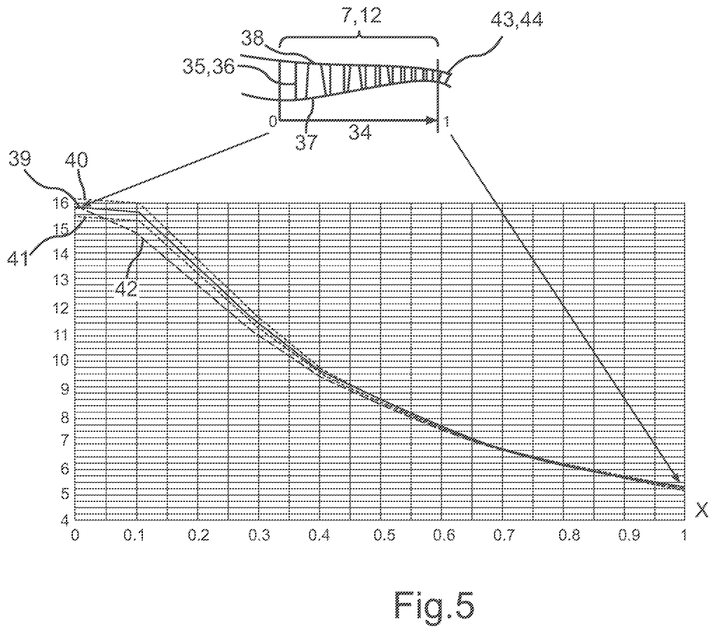

FIG. 5 shows a schematic illustration of a low-pressure compressor flow duct of a low-pressure compressor of a compression system for a gas turbine. The low-pressure compressor flow duct 12 can extend over a low-pressure compressor flow duct length 34 from an inlet cross-sectional area 35 of an inlet guide vane assembly 6 of the low-pressure compressor 7 to an outlet cross-sectional area 43 of an outlet guide vane assembly 44 of the low-pressure compressor 7. The low-pressure compressor flow duct 12 can be delimited radially inwardly by a duct inner wall 37 of the low-pressure compressor 7 and radially outwardly by a duct outer wall 38 of the low-pressure compressor 7. The low-pressure compressor flow duct 12 can be provided for conducting air along a flow path 4 from the inlet guide vane assembly 6 of the low-pressure compressor 7 to the outlet guide vane assembly 44 of the low-pressure compressor 7. Along the low-pressure compressor flow duct length 34, it is possible for the cross-sectional areas 17 of the low-pressure compressor flow duct 12 to have sizes 28 that can be defined relatively in relation to a size of the outlet cross-sectional area 8 of the outlet guide vane assembly 9 of the high-pressure compressor 10. The curve can be described by the values listed in Table 1 below.

| | Low-pressure compressor | | |
|---|---|---|---|
| Relative vane | Lower limit | | Upper limit |
| assembly | of the size | Size curve | of the size |
| position (x) | curve (41) | (39) | curve (40) |
| 0% | 15.4 | 15.8 | 16.1 |
| 10% | 15.3 | 15.6 | 15.9 |
| 20% | 13.3 | 13.5 | 13.8 |
| 30% | 11.2 | 11.3 | 11.5 |
| 40% | 9.4 | 9.5 | 9.7 |
| 50% | 8.2 | 8.3 | 8.4 |
| 60% | 7.2 | 7.3 | 7.4 |
| 70% | 6.5 | 6.5 | 6.6 |
| 80% | 5.9 | 5.9 | 5.9 |
| 90% | 5.4 | 5.4 | 5.4 |
| 100% | 5.1 | 5.1 | 5.1 |

Table 1 shows the possible values of the sizes of the respective cross-sectional areas of the low-pressure compressor.

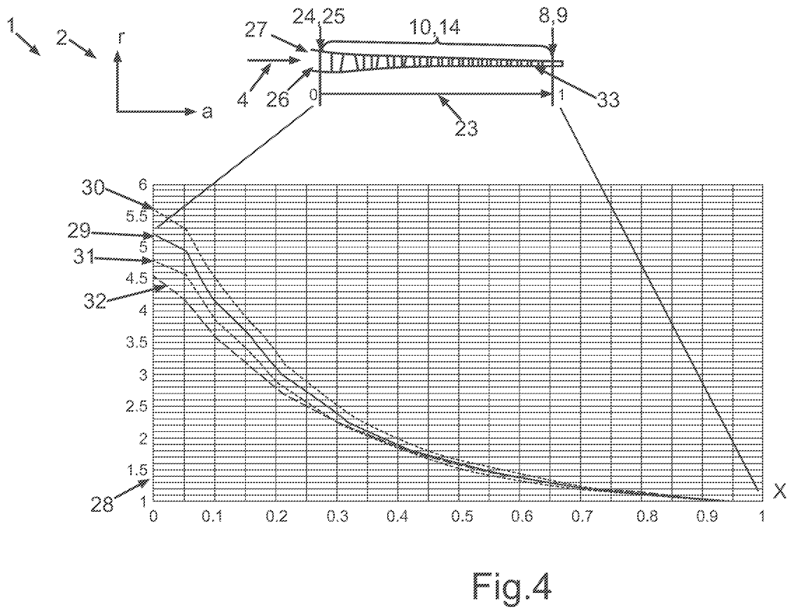

FIG. 4 shows a schematic illustration of a flow duct of the high-pressure compressor of a high-pressure compressor of a compression system for a gas turbine. The high-pressure compressor duct 14 can extend over a high-pressure compressor flow duct length 23 from an inlet cross-sectional area 24 of an inlet guide vane assembly 25 of the high-pressure compressor 10 to an outlet cross-sectional area 8 of an outlet guide vane assembly 9 of the high-pressure compressor 10. The high-pressure compressor flow duct 14 can be delimited radially inwardly by a duct inner wall 26 of the high-pressure compressor 10 and radially outwardly by a duct outer wall 27 of the high-pressure compressor 10. The high-pressure compressor flow duct 14 can be provided for conducting air along a flow path 4 from the inlet guide vane assembly 25 of the high-pressure compressor 10 to the outlet guide vane assembly 9 of the high-pressure compressor 10. Along the high-pressure compressor flow duct length 23, it is possible for the cross-sectional areas 17 of the high-pressure compressor flow duct 14 to have sizes 28 that can be defined relatively in relation to a size of the outlet cross-sectional area 8 of the outlet guide vane assembly 9 of the high-pressure compressor 10. The curve can be described by the values listed in Table 2.

In order to minimize any air resistance when air is conducted through the high-pressure compressor flow duct 14, it may be necessary to design the cross-sectional areas 17, which are arranged at respective positions along the high-pressure compressor flow duct 14 of the high-pressure compressor flow duct length 23, in such a way that, by way of a size curve 29, a minimal air resistance acts. The sizes 28 of the respective cross-sectional areas 17 can be defined in relation to the size of the outlet cross-sectional area 8 of the outlet guide vane assembly 9 of the high-pressure compressor 10. In other words, the sizes 28 of the respective cross-sectional areas 17 can be relatively defined, with it being possible to define the sizes 28 of the respective cross-sectional areas 17 in relation to the size of the outlet cross-sectional area 8 of the high-pressure compressor 10. It is possible to define at least some of the sizes 18 of the respective cross-sectional areas 17 at predetermined positions along the high-pressure compressor flow duct length 23. The positions of the respective cross-sectional areas 17 can likewise be defined and be set in relation to the high-pressure compressor flow duct length 23. The respective positions can be defined by distances of the respective cross-sectional areas 17 from the inlet cross-sectional area 24 of the inlet guide vane assembly 25 of the high-pressure compressor 10, whereby the distance can be predetermined relatively in relation to the high-pressure compressor flow duct length 23. In particular, it is possible for a distance of a length of 0% of the high-pressure compressor flow duct length 23 to describe the position of the inlet cross-sectional area 4 of the high-pressure compressor 10, a distance of a length of 50% of the high-pressure compressor flow duct length 23 to describe a position in the middle of the high-pressure compressor flow duct 14, and a distance of a length of 100% of the high-pressure compressor flow duct length 23 to describe a position of the outlet cross-sectional area 8 of the outlet guide vane assembly 9 of the high-pressure compressor 10. The sizes 28 of the cross-sectional areas 17 are given here in relation to the high-pressure compressor flow duct 14 itself and thus do not take into account reductions in the sizes 28 of the cross-sectional areas 17 due to areas of the vanes of the guide vane assembly 33.

The respective sizes 28 can lie in a range of values, so that a size curve 29 over the flow duct length of the high-pressure compressor can have an upper limit 30 and a lower limit 31. Additionally shown is a size curve 32 in accordance with the prior art. In particular, it can be seen that, in a distance range between 0.3 of the flow duct length of the high-pressure compressor, a greater slope is already provided than is the case in the curve in accordance with the prior art.

| | High-pressure compressor | | |
|---|---|---|---|
| Relative vane | Lower limit | | Upper limit |
| assembly | of the size | Size curve | of the size |
| position (x) | curve (31) | (29) | curve (30) |
| 0% | 4.8 | 5.2 | 5.6 |
| 6% | 4.5 | 4.9 | 5.2 |
| 11% | 3.8 | 4.1 | 4.4 |
| 17% | 3.3 | 3.6 | 3.8 |
| 22% | 2.8 | 3.0 | 3.2 |
| 28% | 2.5 | 2.6 | 2.8 |
| 33% | 2.1 | 2.3 | 2.4 |
| 39% | 1.9 | 2.0 | 2.1 |
| 44% | 1.7 | 1.8 | 1.9 |
| 50% | 1.6 | 1.7 | 1.7 |
| 56% | 1.5 | 1.5 | 1.6 |
| 61% | 1.4 | 1.4 | 1.5 |
| 67% | 1.3 | 1.3 | 1.4 |
| 72% | 1.2 | 1.2 | 1.3 |
| 78% | 1.2 | 1.2 | 1.2 |
| 83% | 1.1 | 1.1 | 1.1 |
| 89% | 1.1 | 1.1 | 1.1 |
| 94% | 1.0 | 1.0 | 1.0 |
| 100% | 1.0 | 1.0 | 1.0 |

Table 2 shows possible values of the sizes of the respective cross-sectional areas of the high-pressure compressor.

It can be provided that the inlet cross-sectional area 24 of the high-pressure compressor 10 has a size 28, which amounts to 4.8 to 5.6 times the size 28 of the outlet cross-sectional area 8, and/or
a cross-sectional area 17 arranged at a distance of 11% of the high-pressure compressor flow duct length 23 from the inlet cross-sectional area 24 of the high-pressure compressor 10 has a size 28, which amounts to 3.8 to 4.4 times the size 28 of the outlet cross-sectional area 8, and/or
a cross-sectional area 17 arranged at a distance of 22% of the high-pressure compressor flow duct length 23 from the inlet cross-sectional area 24 of the high-pressure compressor 10 has a size 28, that amounts to 2.8 to 3.3 times the size 28 of the outlet cross-sectional area 8, and/or
a cross-sectional area 17 arranged at a distance of 33% of the high-pressure compressor flow duct length 23 from the inlet cross-sectional area 24 of the high-pressure compressor 10 has a size 28, which amounts to 2.1 to 2.4 times the size 28 of the outlet cross-sectional area 8, and/or
a cross-sectional area 17 arranged at a distance of 39% of the high-pressure compressor flow duct length 23 from the inlet cross-sectional area 24 of the high-pressure compressor 10 has a size 28, which amounts to 1.9 to 2.1 times the size 28 of the outlet cross-sectional area 8, and/or
a cross-sectional area 17 arranged at a distance of 50% of the high-pressure compressor flow duct length 23 from the inlet cross-sectional area 24 of the high-pressure compressor 10 has a size 28, which amounts to 1.6 to 1.7 times the size 28 of the outlet cross-sectional area 8, and/or
a cross-sectional area 17 arranged at a distance of 61% of the high-pressure compressor flow duct length 23 from the inlet cross-sectional area 24 of the high-pressure compressor 10 has a size 28, which amounts to 1.4 to 1.5 times the size 28 of the outlet cross-sectional area 8, and/or
a cross-sectional area 17 arranged at a distance of 72% of the high-pressure compressor flow duct length 23 from the inlet cross-sectional area 24 of the high-pressure compressor 10 has a size 28, which amounts to 1.2 to 1.3 times the size 28 of the outlet cross-sectional area 8, and/or
a cross-sectional area 17 arranged at a distance of 83% of the high-pressure compressor flow duct length 23 from the inlet cross-sectional area 24 of the high-pressure compressor 10 has a size 28, which amounts to 1.1 times the size 28 of the outlet cross-sectional area 8, and/or
a cross-sectional area 17 arranged at a distance of 89% of the high-pressure compressor flow duct length 23 from the inlet cross-sectional area 24 of the high-pressure compressor 10 has a size 28, which amounts to 1.1 times the size 28 of the outlet cross-sectional area 8.

What is claimed is:

1. A compression system for an aircraft gas turbine, comprising:
a flow duct, which extends from an inlet cross-sectional area of an inlet guide vane assembly of a low-pressure compressor of the compression system over a flow duct length extending in an axial direction of the compression system to an outlet cross-sectional area of an outlet guide vane assembly of a high-pressure compressor of the compression system, wherein
the flow duct being delimited radially inwardly by a duct inner wall of the compression system and radially outwardly by a duct outer wall of the compression system, wherein
the flow duct comprises cross-sectional areas that are aligned perpendicular to the axial direction along the flow duct length and have the respective predetermined sizes, wherein
the inlet cross-sectional area has a size that is 15.3 to 16.1 times a size of the outlet cross-sectional area, and/or
a cross-sectional area arranged at a distance of 40% of the flow duct length from the inlet cross-sectional area has a size that is 5.0 to 5.2 times the size of the outlet cross-sectional area, and/or
a cross-sectional area arranged at a distance of 60% of the flow duct length from the inlet cross-sectional area has a size that is 2.0 to 2.2 times the size of the outlet cross-sectional area.

2. The compression system according to claim 1, wherein
a cross-sectional area arranged at a distance of 10% of the flow duct length from the inlet cross-sectional area has a size that is 10.9 to 11.5 times the size of the outlet cross-sectional area, and/or
a cross-sectional area arranged at a distance of 30% of the flow duct length from the inlet cross-sectional area has a size that is 5.2 to 5.5 times the size of the outlet cross-sectional area, and/or
a cross-sectional area arranged at a distance of 50% of the flow duct length from the inlet cross-sectional area has a size that is 3.0 to 3.4 times the size of the outlet cross-sectional area, and/or
a cross-sectional area arranged at a distance of 70% of the flow duct length from the inlet cross-sectional area has a size that is 1.5 to 1.6 times the size of the outlet cross-sectional area.

3. The compression system according to claim 1, wherein
a cross-sectional area arranged at a distance of 35% of the flow duct length from the inlet cross-sectional area has a size that is 4.6 to 4.8 times the size of the outlet cross-sectional area, and/or
a cross-sectional area arranged at a distance of 37.5% of the flow duct length from the inlet cross-sectional area has a size that is 4.8 to 5.2 times the size of the outlet cross-sectional area, and/or
a cross-sectional area arranged at a distance of 42.5% of the flow duct length from the inlet cross-sectional area has a size that is 4.6 to 4.8 times the size of the outlet cross-sectional area, and/or
a cross-sectional area arranged at a distance of 45% of the flow duct length from the inlet cross-sectional area has a size that is 4.0 to 4.2 times the size of the outlet cross-sectional area.

4. The compression system according to claim 1, wherein
a cross-sectional area arranged at a distance of 80% of the flow duct length from the inlet cross-sectional area has a size (18) that is 1.2 to 1.3 times the size of the outlet cross-sectional area.

5. A high-pressure compressor for a compression system for an aircraft gas turbine, comprising:
a high-pressure compressor flow duct, which extends from an inlet cross-sectional area of an inlet guide vane assembly of the high-pressure compressor over a high-pressure compressor flow duct length extending in an axial direction of the high-pressure compressor to an outlet cross-sectional area of an outlet guide vane assembly of the high-pressure compressor, wherein
the high-pressure compressor flow duct is delimited radially inwardly by a duct inner wall of the high-pressure compressor and radially outwardly by a duct outer wall of the high-pressure compressor, wherein
the high-pressure compressor flow duct comprises cross-sectional areas that are aligned perpendicular to the axial direction along the high-pressure compressor flow duct length and have the respective predetermined sizes, wherein
the inlet cross-sectional area of the inlet guide vane assembly of the high-pressure compressor has a size that is 4.8 to 5.6 times a size of the outlet cross-sectional area, and/or
a cross-sectional area arranged at a distance of 22% of the high-pressure compressor flow duct length from the inlet cross-sectional area of the high-pressure compressor has a size that is 2.8 to 3.3 times the size of the outlet cross-sectional area, and/or
a cross-sectional area arranged at a distance of 39% of the high-pressure compressor flow duct length from the inlet cross-sectional area of the high-pressure compressor has a size that is 1.9 to 2.1 times the size of the outlet cross-sectional area, and/or
a cross-sectional area arranged at a distance of 61% of the high-pressure compressor flow duct length from the inlet cross-sectional area of the high-pressure compressor has a size that is 1.4 to 1.5 times the size of the outlet cross-sectional area, and/or
a cross-sectional area arranged at a distance of 83% of the high-pressure compressor flow duct length from the inlet cross-sectional area of the high-pressure compressor has a size that is 1.1 times the size of the outlet cross-sectional area.

6. The high-pressure compressor according to claim 5, wherein
a cross-sectional area arranged at a distance of 11% of the high-pressure compressor flow duct length from the inlet cross-sectional area of the high-pressure compressor has a size that is 3.8 to 4.4 times the size of the outlet cross-sectional area, and/or
a cross-sectional area arranged at a distance of 33% of the high-pressure compressor flow duct length from the inlet cross-sectional area of the high-pressure compressor has a size that is 2.1 to 2.4 times the size of the outlet cross-sectional area, and/or
a cross-sectional area arranged at a distance of 50% of the high-pressure compressor flow duct length from the inlet cross-sectional area of the high-pressure compressor has a size that is 1.6 to 1.7 times the size of the outlet cross-sectional area (8), and/or
a cross-sectional area arranged at a distance of 72% of the high-pressure compressor flow duct length from the inlet cross-sectional area of the high-pressure compressor has a size that is 1.2 to 1.3 times the size of the outlet cross-sectional area, and/or
a cross-sectional area arranged at a distance of 89% of the high-pressure compressor flow duct length from the inlet cross-sectional area of the high-pressure compressor) has a size that is 1.1 times the size of the outlet cross-sectional area.

7. A compression system for an aircraft gas turbine, comprising at least one high-pressure compressor according to claim 5.

8. A low-pressure compressor of a compression system for an aircraft gas turbine, comprising:
a low-pressure compressor flow duct, which extends from an inlet cross-sectional area of an inlet guide vane assembly of the low-pressure compressor over a low-pressure duct length extending in an axial direction of the low-pressure compressor to an outlet cross-sectional area of an outlet guide vane assembly of the low-pressure compressor,
the compression system comprises a flow duct, which extends from the inlet cross-sectional area of the inlet guide vane assembly of the low-pressure compressor of the compression system over a flow duct length extending in the axial direction of the compression system to an outlet cross-sectional area of an outlet guide vane assembly of a high-pressure compressor of the compression system, wherein
the low-pressure compressor flow duct is delimited radially inwardly by a duct inner wall of the low-pressure compressor and radially outwardly by a duct outer wall of the low-pressure compressor, wherein
the low-pressure compressor flow duct comprises cross-sectional areas that are aligned perpendicular to the axial direction along the low-pressure compressor flow duct length and have the respective predetermined sizes, wherein
the inlet cross-sectional area of the inlet guide vane assembly of the low-pressure compressor has a size that is 15.4 to 16.1 times a size of the outlet cross-sectional area of the outlet guide vane assembly of the high-pressure compressor, and/or
a cross-sectional area arranged at a distance of 20% of the low-pressure compressor flow duct length from the inlet cross-sectional area of the low-pressure compressor has a size that is 13.3 to 13.8 times the size of the outlet cross-sectional area of the outlet guide vane assembly of the high-pressure compressor, and/or
a cross-sectional area arranged at a distance of 40% of the low-pressure compressor flow duct length from the inlet cross-sectional area of the low-pressure compressor has a size that is 9.4 to 9.7 times the size of the outlet cross-sectional area of the outlet guide vane assembly of the high-pressure compressor, and/or
a cross-sectional area arranged at a distance of 60% of the low-pressure compressor flow duct length from the inlet cross-sectional area of the low-pressure compressor has a size that is 7.2 to 7.4 times the size of the outlet cross-sectional area of the outlet guide vane assembly of the high-pressure compressor, and/or
a cross-sectional area arranged at a distance of 80% of the low-pressure compressor flow duct length from the inlet cross-sectional area of the low-pressure compressor has a size that is 5.9 times the size of the outlet cross-sectional area of the outlet guide vane assembly of the high-pressure compressor, and/or
the outlet cross-sectional area of the outlet guide vane assembly of the low-pressure compressor has a size that is 5.1 times a size of the outlet cross-sectional area of the outlet guide vane assembly of the high-pressure compressor.

9. The low-pressure compressor according to claim 8, wherein
a cross-sectional area arranged at a distance of 10% of the low-pressure compressor flow duct length from the inlet cross-sectional area of the low-pressure compressor has a size that is 15.3 to 15.9 times the size of the outlet cross-sectional area of the outlet guide vane assembly of the high-pressure compressor, and/or
a cross-sectional area arranged at a distance of 30% of the low-pressure compressor flow duct length from the inlet cross-sectional area of the low-pressure compressor has a size that is 11.2 to 11.5 times the size of the outlet cross-sectional area of the outlet guide vane assembly of the high-pressure compressor, and/or
a cross-sectional area arranged at a distance of 50% of the low-pressure compressor flow duct length from the inlet cross-sectional area of the low-pressure compressor has a size that is 8.2 to 8.4 times the size of the outlet cross-sectional area of the outlet guide vane assembly of the high-pressure compressor, and/or
a cross-sectional area arranged at a distance of 70% of the low-pressure compressor flow duct length from the inlet cross-sectional area of the low-pressure compressor has a size that is 6.5 to 6.6 times the size of the outlet cross-sectional area of the outlet guide vane assembly of the high-pressure compressor, and/or
a cross-sectional area arranged at a distance of 90% of the low-pressure compressor flow duct length from the inlet cross-sectional area of the low-pressure compressor has a size that is 5.4 times the size of the outlet cross-sectional area of the outlet guide vane assembly of the high-pressure compressor.

10. A compression system for an aircraft gas turbine, comprising at least one low-pressure compressor according to claim 8.

11. A gas turbine, comprising at least one compression system according to claim 1.
